(19) United States
(12) Patent Application Publication
(10) Pub. No.: US 2020/0270146 A1
(43) Pub. Date: Aug. 27, 2020

(54) SIDE-LOADING TRANSVERSE SHOWER FILTER

(71) Applicant: David K. Farley, Corona, CA (US)

(72) Inventor: David K. Farley, Corona, CA (US)

(21) Appl. No.: 16/286,097

(22) Filed: Feb. 26, 2019

(51) Int. Cl. C02F 1/00; B05B 15/40; B05B 1/18; E03C 1/04

(52) U.S. Cl. CPC C02F 1/003; B05B 15/40; E03C 2201/40; E03C 1/0409; C02F 2307/06; B05B 1/185

(57) ABSTRACT

A side-loading shower filter having a body that may be easily be mounted between a shower arm and a showerhead without the need of special tools. The body has removable end caps to allow a water filter cartridge to be added to or removed from either side of a transverse hollow water filter cartridge chamber formed in the body by the removal of either of the pair of end caps. The shower filter is mounted between a shower arm and a showerhead by means of coupling means connected to a water inlet and a water outlet formed in the body.

### BACKGROUND OF THE INVENTION

### b1. Field of the Invention

This invention generally relates to filters for shower heads and, more particularly, to a side-loading transverse shower filter for insertion between a shower arm and a shower head.

### 2. Description of the Prior Art

Shower filters in or for use in conjunction with shower heads in showers are known. For example, filters are inserted at ends of shower arms, with shower heads then secured to the filters, or shower heads having filters incorporated therein (hereinafter “filtered shower head”) are attached directly to the ends of the shower arms. However, because of the size of the filter and the attached shower head or the filtered shower head, they may extend too far into the shower area. Furthermore, the known filters or filtered shower heads add weight to the shower arm, which over time may cause problems. Additionally, the known filters are limited in how they may be adjusted and/or added to a shower arm and how a filter cartridge may be inserted into or removed from filter housing. Such known filters also tend to be costly to manufacture and are not used by some persons because of their size or style and difficulty for some people in inserting in, or removing the shower filter cartridge from, the filter housing. For example, the known filters do not always match a person's aesthetic taste, and/or the overall decor of a bathroom or shower area. Finally, the known filters cannot be used with large, modern showerheads, such as the flower shaped or watering can type, and do not have an integrated feel or look when used with known shower arms.

Known shower filter and filtered shower head assemblies are set forth in U.S. Pat. Nos. 5,152,464, 5,300,224, 5,503,742, 6,016,977, 6,187,187, 6,214,224, 6,270,023, 6,325,930 and 6,537,455 to Farley.

While the foregoing prior art devices allow for different spray or flow control and provide improved filtration of water passing through them, they do not provide for a transverse shower filter that may be loaded from the side and that may be attached or secured to a shower arm so as to provide increased aesthetics and functionality. The shower filter of the present invention provides a filter housing that may have a filter cartridge loaded from either side, or transversely to the water flow, when mounted between a shower head and a shower arm thereby overcoming many of the problems with known shower filters. Additionally, a water filter cartridge is easily inserted into and removed from the filter housing of the present invention by means of a cap on at least one end of the transverse filter housing, thereby allowing for ease in changing the filter cartridge.

Therefore, there exists a need in the art for a less cumbersome, easy-to-install and move, shower filter system that overcomes known problems and provides a filter housing with a transverse shower filter cartridge chamber that allows a filter cartridge to be added to and removed from the filter housing from at least one side.

### SUMMARY OF THE INVENTION

The shower filter of the present invention provides many advantages including, but not limited to the following:

1) Minimizes showerhead extension by use of a shower filter placed transversely to a shower arm and showerhead that minimizes showerhead extension; as opposed to the increased extension created by an in-line shower filter.

2) Side-loading of a replacement filter cartridge in the shower filter eliminates the requirement for removal of the showerhead from the shower arm and, except for the unscrewing of an end cap, disassembly of the shower filter to remove the shower filter cartridge. This novel side-loading of a replacement cartridge, from at least one side, but preferably either side, makes changing of a filter cartridge easier, resulting in the exchanging of filter cartridges more often, to thereby maintain maximum filtration.

3) The size, shape and placement of the transverse shower filter chamber acts as a counter-balance to the showerhead if raised. The shower filter may be manufactured from any material, such as a metal or a sturdy plastic compatible with water.

4) In known shower filters or filtered showerheads water normally flows horizontally through an even bed of granular media and the granules tend to compact unevenly creating spaces or voids due to the combined effects of hydro-dynamics, specific weight of the individual granules and gravity. As the water continues to flow through the filter bed, the voids expand forming channels. Since water travels the path of least resistance, the water flow increases through the channel while expanding the size of the channels resulting in poor filtration performance as even less water contacts the filtration media. However, the transverse shower filter of the present invention directs the water through the filtration bed perpendicularly to the shower arm. As the water flows through the granules are loosened and through the effects of gravity, resettle, compacting evenly without forming voids or channels. This results in maximum water/to media contact and therefore optimum filtration performance.

Providing at least one, but preferably two removable end caps on the transverse shower filter housing allows a user to more easily, selectively add to, or remove a filter cartridge from the filter housing.

Accordingly, it is a general object of the present invention to provide an improved transverse shower filter assembly. It is a more particular object of the present invention to provide a side-loading transverse shower filter system. It is a further object of the present invention to provide a side-loading transverse shower filter assembly connected between a shower arm and a showerhead that minimizes extension of the showerhead into the shower area. It is yet another object of the present invention to provide a side-loading transverse shower filter wherein a user may easily add to or replace a filter cartridge. It is a still further object of the present invention to provide a novel side-loading shower filter that has an integrated design which is more aesthetically pleasing and allows easy access to the filter cartridge.

In accordance with one aspect of the present invention there is provided, a side-loading shower filter having a transverse housing with removable end caps that may be easily mounted between a shower arm and a showerhead without the need of special tools.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, wherein:

FIG. 1 is a perspective front view of a first embodiment of a transverse side-loading shower filter of the present invention; and

FIG. 2 is a cross-sectional view of a second embodiment of a transverse side-loading shower filter of the present invention.

### DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide for a transverse side-loading shower filter for mounting between a shower arm and a showerhead.

The transverse side-loading shower filter of the present invention is mounted directly on a regular shower arm coming out of a shower wall, and is normally connected or secured to the shower arm by screwing thereon, or by means of a separate coupling means, with a further coupling means connecting the shower filter to a showerhead that extends into the shower area. Removable end caps on the transverse filter housing allow a shower filter cartridge to be side-loaded from either end of the transverse filter housing.

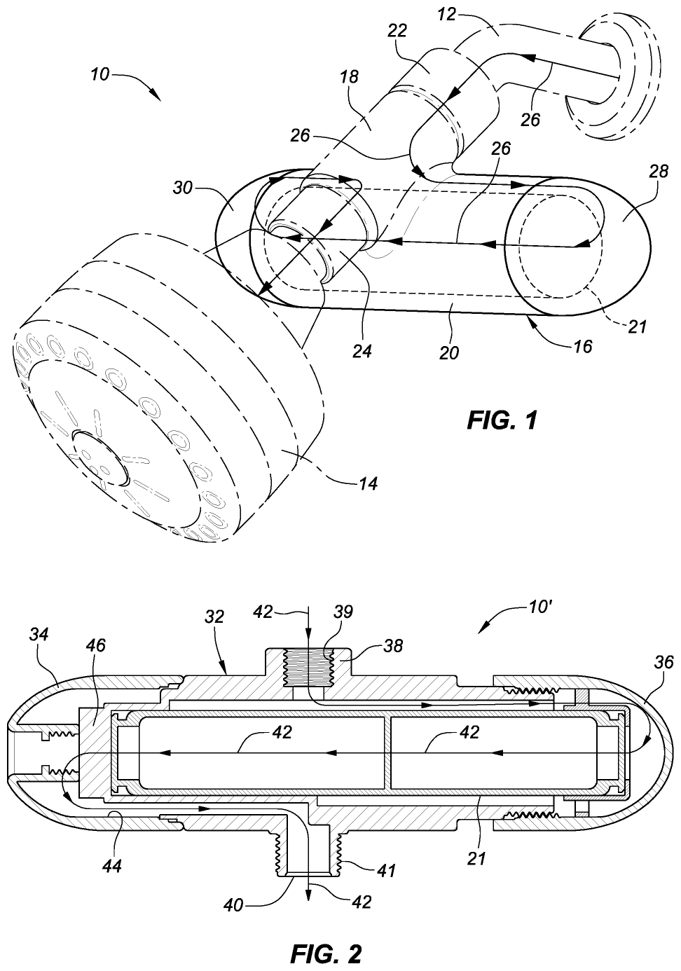

Turning now to the drawings, FIG. 1 illustrate a first embodiment of a transverse side-loading shower filter 10 of the present invention connected between a shower arm 12 and a showerhead 14. The transverse side-loading shower filter 10 includes a hollow body or housing 16 having an integral, offset top or upper connecting portion or means 18 mounted on or secured to an upper surface of a transverse filter housing portion 20. The offset connecting portion 18 is fluidly connected to the filter housing portion 20 by means of openings formed therein, as well as internal baffles, deflectors or walls to allow water flowing from the shower arm 12 to pass through an inlet end or coupling 22 into connecting portion 18 and to be deflected down, through an opening, into the transverse filter housing 20 where it flows around an exterior surface of a filter cartridge 21 (shown in broken line) removably held in the filter housing, into an end cap 28, through filter media held in the filter cartridge into end cap 30, and then back through an opening into the offset connecting portion 18 where it is deflected into a further coupling means 24 and into the showerhead 14. This flow of the water is illustrated by arrows 26 in FIG. 1.

The end caps 28, 30 at the ends of hollow housing 20 are removably held on the ends by screw threads or similar holding means formed internally of the end caps and on the outer ends of the transverse filter housing to allow removal of an older filter cartridge 21, or side-loading of a new filter cartridge 21, when either end cap is taken off. Sealing means to prevent leakage are provided between the interior of the end caps and the exterior of the outer ends of the filter housing.

Turning now to FIG. 2, there shown is a cross-sectional view of a second embodiment of the invention 10′, which, for the sake of description only, is referred to as a direct flow device. This device 10′ has an elongated hollow body 32 with end caps 34, 36, an inlet 38 having internal screw threads 39 and an outlet 40 having external screw threads 41. The body is substantially identical on both sides and the inlet 38 may be mounted on or to a shower arm 12 by screwing the inlet directly thereon or by screwing a separate coupling means between the shower arm and the inlet 38. The outlet 40 is mounted to the showerhead 14 by screwing the showerhead directly thereon or by insertion of a separate coupling means between the showerhead 14 and the outlet 40.

Water flow through shower filter 10′ from the shower arm 12 is illustrated by arrows 42 as it passes through the inlet 38 into a hollow filter cartridge chamber formed in the elongated hollow body 32 where it is deflected around the outer body of the filter cartridge 21 and by the end cap 36 and into the filter cartridge 21 where it passes through filter media in the cartridge to exit into end cap 34 where it is deflected into a side passage 44 formed internally in the elongated hollow body 32 by means of a wall 46 formed at an outer end thereof, and then out the outlet 40 into an attached showerhead, such as 14.

In use, when either of the side-loading transverse shower filters 10 or 10′ are properly mounted between the shower arm 12 and showerhead 14, as described above, they allow water to flow through the filter cartridge 21. The shower filters 10, 10′ are sized and dimensioned to snugly and securely hold the filter cartridge 21 therein, spaced from or abutting an extension formed in, or an interior surface of the end caps, when they are tightened. Water passes through a filter media bed and exits the filter housing where the filtered water passes through the showerhead and into the shower area.

The side-loading transverse shower filters of the present invention may take any number of other different configurations, depending on the aesthetic look desired, and may be made from any desired material, such as metal or a thermoplastic, for example, as by casting or any other known or improved manufacturing means.

It, therefore, can be seen that the present invention provides an improved less cumbersome, easy-to-install and use shower water filter assembly providing an integrated design, with a single transverse housing having inlets and outlets that may be easily coupled between any available shower arm and showerhead without the need of special tools or adapters.

Those skilled in the art will appreciate that various adaptations and modifications of the just-described preferred embodiment may be configured without departing from the scope and spirit of the invention. Therefore, it is to be understood that, within the scope of the appended claims, the invention may be practiced other than is specifically described herein.

What is claimed is:

1. A shower filter, comprising;
a hollow housing having a water inlet and a water outlet for coupling between a shower arm and a showerhead;
a hollow water filter cartridge chamber formed transversely to water entering and exiting the housing and,
at least one end cap removably mounted on the hollow water filter cartridge chamber to allow side-loading of a water filter cartridge.

2. The water filter of claim 1, further including a removable water filter cartridge held in the hollow water filter cartridge chamber.

3. The water filter of claim 2, wherein there are a pair of end caps removably mounted on opposite ends of the hollow water filter cartridge chamber for holding the removable water filter cartridge therein.

4. The water filter of claim 3, further including passage means in the hollow water filter cartridge chamber to allow water entering the inlet to flow around and through the removable water filter cartridge and out the water outlet.

5. The water filter system of claim 4 wherein the housing is comprised of a top connector integrally coupled to the transverse hollow filter cartridge chamber.

6. The water filter system of claim 4 wherein the housing is comprised of the transverse water filter cartridge chamber with the water inlet and the water outlet integrally formed thereon on opposed side portions.

7. A water filter for a shower system, comprising;
a hollow housing having a water inlet and a water outlet for coupling between a shower arm and a showerhead;
the hollow housing including a hollow water filter cartridge chamber formed transversely to water entering and exiting the housing; and
a pair of end caps removably mounted on opposite ends of the hollow water filter cartridge chamber to allow a water filter cartridge to by selectively loaded from either side end of the hollow water filter cartridge chamber.

8. The water filter of claim 7, further including a removable water filter cartridge held in the hollow water filter cartridge chamber.

9. The water filter of claim 8, wherein there are a pair of end caps removably mounted on opposite ends of the hollow water filter cartridge chamber include means for holding the removable water filter cartridge in place and for deflecting water entering the end caps.

10. The water filter of claim 8, further including passage means formed in the hollow water filter cartridge chamber to allow water entering the inlet to flow around and through the removable water filter cartridge and out the water outlet.

11. The water filter system of claim 10 wherein the hollow housing is comprised of a top connector integrally coupled to the transverse water filter cartridge chamber.

12. The water filter system of claim 11 wherein the hollow housing is comprised of a transverse water filter cartridge chamber with the water inlet and the water outlet integrally formed thereon on opposed side portions.

13. A water filter for a shower system, comprising;
a transverse hollow housing having a water inlet and a water outlet adapted to be coupled between a shower arm and a showerhead;
the transverse hollow housing including a water filter cartridge held therein; and
the transverse hollow housing having opposed open ends with a pair of end caps removably mounted on the open ends to allow the water filter cartridge to by selectively side-loaded or removed from either end of the hollow water filter cartridge chamber.

14. The water filter of claim 13, wherein the pair of removable end caps include means for holding the removable water filter cartridge in place and for deflecting water entering the end caps.

15. The water filter of claim 14, further including passage means formed in the transverse hollow housing to allow water entering the inlet to flow around and through the removable water filter cartridge and out the water outlet.

16. The water filter system of claim 13 wherein the transverse hollow housing is comprised of a top connector integrally coupled to the transverse water filter cartridge chamber.

17. The water filter system of claim 13 wherein the transverse hollow housing has the water inlet and the water outlet integrally formed thereon on opposed side portions.
